(19) United States
(12) Patent Application Publication
(10) Pub. No.: US 2004/0267572 A1
(43) Pub. Date: Dec. 30, 2004

(54) Process and method of capturing and delivering emergency contact, medical, scheduling information, and appointment reminders

(76) Inventors: Mark Emery, Glendale, AZ (US); David Dean Minor, Phoenix, AZ (US); Eric Godoy, Phoenix, AZ (US); Adam Ceton, Phoenix, AZ (US)

Correspondence Address: MARK EMERY, 4662 WEST FALLEN LEAF LANE, GLENDALE, AZ, 85310, US

(21) Appl. No.: 10/854,693

(22) Filed: May 26, 2004

Related U.S. Application Data
(60) Provisional application No. 60/473,781, filed on May 27, 2003.

(51) Int. Cl. G06F 7/00; G06F 17/30; G06F 17/60

(52) U.S. Cl. 705/2; 705/9; 707/3

(57) ABSTRACT

A system comprising an online database for personal, medical, appointment and other information; means for accessing that database using SSL encrypted links across the global internet; a portable ID card containing written and encoded information that is formatted to support an updateable provider printed and authenticated appliqué; and multiple means for delivering the information contained in the database to a wide variety of recipients on-demand is proposed. The intent of the system is to allow subscribers and providers to privately collaborate on treatments, while still allowing rapid and easy access to certain critical information in the event of an immediate need. The subscriber has the ability to designate service providers and enable their access.

Furthermore, the system enables access for multiple providers to share pertinent information about the subscriber and their conditions and treatments while still restricting how that information can be modified. The system provides for the attachment of multiple types of associated documents or records and includes a complete activity logging utility for historical and archival purposes. Additionally, the system provides a utility for scheduling future appointments and automatic reminders that are trigger or time based can be delivered to subscribers and/or providers by the system.

### CROSS REFERENCE TO RELATED APPLICATIONS

60/473,781 filed May 27, 2003

### FEDERALLY SPONSORED RESEARCH

Not Applicable

### SEQUENCE LISTING OR PROGRAM

Not Applicable

### BACKGROUND OF THE INVENTION-FIELD OF INVENTION

This invention relates to a system comprising an online database, online application, personal identification device, and delivery methods for emergency contact, medical, scheduling information, and appointment reminders.

### BACKGROUND OF THE INVENTION

Readily available and accurate personal contact and medical information can be critical in selecting appropriate treatment of a wholly or partially incapacitated individual in the event of an emergency. Additionally, precious time can be saved in contacting previously involved healthcare providers, insurers, and loved ones if that information is also readily available to emergency personnel. The present invention relates to an integrated system that provides such information, links that information to selectable healthcare providers, provides multiple methods of delivering that information on an on-demand basis, and provides effective means for ensuring that the information that a person is carrying is up-to-date and medically authenticated. Furthermore, the present invention provides an integrated method for scheduling appointments with service providers, including those in healthcare, and a method for automatically reminding the appointee of a forthcoming appointment.

In certain circumstances it is useful and advisable to have reliable personal medical information and contact information readily available. Basic emergency contact and medical ID devices are available. Unfortunately, many available ID devices have significant limitations. For example, some ID devices are limited to just one medical condition. Some ID devices are printed on paper and laminated, but they are without a medical context and without a date context so the information they contain cannot be relied upon; furthermore, there is no readily available means to update the information on the ID device. Some ID devices contain electronics for storing large amounts of information, but require a special and frequently costly device to read and or update the information.

Additionally, very few of the existing ID systems provide direct links for multiple emergency and healthcare providers to view the online data upon which the information on the ID devices is based. Furthermore, none of the systems provide a method for associated providers to schedule appointments and automatically remind the information owner of upcoming appointments.

### BACKGROUND OF THE INVENTION—PRIOR ART

Various patents have been issued in the past that have described a variety of emergency medical ID systems, medical record systems, or ID devices.

Several previous disclosures for emergency medical systems—for example, in U.S. Pat. Nos. 6,223,559 (2001) to Coleman, 2002/0178631 A1 (2002) to Morton, 2002/0189146 A1 (2002) to Lyon, 2003/0098356 (2003) to Gombar, 2003/0132132 A1 (2003) to Small, 2003/0233844 A1 (2003) to Rheinstein, and 20030059751 (2003) to Welles, although of varying configurations and materials, comprise largely of carriers for emergency information or jewelry items inscribed with or carrying printed versions of said information. These devices have the additional disadvantage of having basically static information, or information that is not deliverable by multiple means, nor available to persons remote from the carrier. Furthermore, the information on or in these devices is frequently limited in content and scope by the media.

Other disclosures for emergency medical systems—for example, in U.S. patents 2002/0046061 (2002) to Wright et al, 2002/077861 (2002) to Hogan, 2002/0120470 (2002) to Trice, 20030014292 to Haaksma et al, 20030040940 (2003) to Nehammer comprise a database of varying content accessible by various approved parties, and a method for creating a compact disc version of the output that can be carried by the owner of the information. These systems have the disadvantage of requiring a compact disk writer to prepare and to read the compact disks. This requirement, along with the fragile nature of the disk surface, can easily make the data unusable in an emergency situation due to lack of equipment or damage.

Other disclosures for medical records system—for example, in U.S. Pat. Nos. 2,002,0103675 (2002) to Vanelli, 20030140044 (2003) to Mok et al, 20030208382 to (2003) to Westfall, and 20040078229 (2004) to Gay et al, comprise a detailed online medical records system with the primary function of allowing the subscriber to have 24 hour access via the internet to their information and/or allowing permitted providers the ability to add and modify that information. These systems contain significant amounts of medical information but have the disadvantages of requiring direct access to the database for information, lack of an inexpensive information container for the carrier, and lack of an emergency information delivery system and/or appointment system.

There are also disclosures for emergency location and information systems—for example, in U.S. Pat. No. 2,003,0226889 (2003) by Morrison, an online database is proposed that contains personal information and location information that is combined with a simple card containing a user identifier and system password. This system is simple in context but has the disadvantages of limited information at the card location, limited protection of the carrier's private information, and the lack of selectable links with healthcare providers.

There is also a disclosure for emergency service access using a mobile phone—for example in U.S. Pat. No. 6,574,484 (2003) to Carley, a 911 call solicits direct delivery to an emergency point of service, by phone number association, of an abbreviated set of emergency medical information. This enables ready and simple access to certain information, but has the disadvantages of not having information directly on the individual's person for non-emergency situations, no ties to selectable medical providers, no easy way and ubiquitous method of updating the information, and no scheduling nor appointment capabilities.

There are also disclosures for medical identification smart cards—for example in U.S. Pat. Nos. 2,002,0128865 (2002) by Alten, 20030037065 (2003) by Svab, 20030086591 (2003) by Simon, and 6,725,200 by Rost, a radio coupled card, one with identifying DNA biometrics, or one configured as a PCMCIA device and internal memory is proposed to be carried by a person. Such a card can carry significant amounts of information, can be linked to a centralized database, and can be used in various medical service locations. The disadvantage of these methods is the requirement for special equipment to read the card contents, something that is not ubiquitously available.

All of the emergency contact, medical ID, medical record, and notification systems heretofore known suffer from some combination of the following disadvantages:

(a) The information on the included ID cards or portable media is very limited;

(b) The information on the included ID cards or portable media is not readily nor automatically updateable;

(c) The information on the included ID cards or portable media cannot be accessed using multiple methods;

(d) A special device is needed to read the information on the included ID card or portable media;

(e) The most recent information cannot be sent, on-demand, to a standard messaging device such as a cell phone or pager;

(f) The individual's information is not linked to a restricted set of permitted healthcare providers;

(g) The medical information is not authenticated by a linked card owner permitted healthcare provider;

(h) The information in the database and/or on the portable media is not maintained in a private fashion;

(i) The system or database used to contain the information does not keep an historical log of changes, identifying who modified what information and when;

(j) The system or database used to contain the information does not permit the attachment of other medically pertinent records or materials;

(k) The system or database used to contain the information does not include a scheduling system applicable to health care providers or other service providers;

(l) The system or database used to contain the information does not include an automatic appointment reminder system for the healthcare or other service provider that delivers appointment reminders to the card owner.

### BACKGROUND OF THE INVENTION-OBJECTS AND ADVANTAGES

The objects and advantages of the present invention hereafter referred to as the Life+ID system are:

(a) to provide a readily accessible database that includes personal, personal contact, medical information, and scheduling information;

(b) to provide a readily accessible database that can be also be used for other entities, such as pets;

(c) to provide a method that allows the individual to enter and update their information;

(d) to provide a method that allows multiple healthcare providers permitted access to that information and a method for entering and updating the medical and scheduling portions of it;

(e) to provide a method that allows multiple healthcare providers to view the information that other healthcare providers have entered;

(f) to provide methods for an individual provider to examine and manage all associated subscribers;

(g) to provide a method of attaching pertinent medical information or records to an individual's information;

(h) to provide a method for tracking and logging all access to an individual's information;

(i) to provide a method for securing and protecting an individual's information;

(j) to provide a method of quickly delivering an individual's information to emergency or healthcare personnel on-demand;

(k) to provide a method of carrying a highly portable and abbreviated version of that information on a person;

(l) to provide a method of carrying a highly portable and abbreviated version of that information on another entity, such as a pet;

(m) to provide a method for permitted healthcare personnel to update and authenticate the portable version of that information;

(n) to provide a method of automatically notifying a person of a forthcoming appointment with an associated provider;

(O) to provide an ecommerce engine to enable billing and account reconciliation.

### SUMMARY

The present invention is a system comprising a centralized secure database containing a subscriber's personal, emergency contact, medical, scheduling, and historical information; an online application; an ID card with printed information and encoded information; an ID card appliqué for information revisions; methods for linking one or many healthcare providers to a subscriber; methods for updating said information; methods for attaching pertinent external medical information or records to that information; methods for tracking access to said information; methods for transmitting said information to a text messaging device or via email; methods for scheduling and assigning appointment information; and methods for automatically transmitting that appointment information to a text messaging device or via email.

The database in its described embodiment is centralized and available via the internet. Access to the database is contingent upon approved user identity and password—the data is encrypted for protection in the case of non-authorized access and access is only through SSL links.

The described embodiment of the ID card contains printed, biometric, and encoded information. Furthermore, the card employs a simple and inexpensive method of update using a printed appliqué on one side that can easily be generated and authorized by an associated provider at their location.

The system contains interfaces that enable data access via a local area network or internet using common browser technology and all of the known computing functions of display, printing, etc. Furthermore, the system contains interfaces that enable transmission of specified information via email or text messaging protocols at scheduled intervals or on-demand.

The system also contains methods that enable the association of a time-based or trigger based event with a particular subscriber, and/or provider.

The features and advantages of the present invention will be apparent to those of ordinary skill in the art in view of the detailed description of the preferred embodiments, which are made with reference to the drawings, a brief description of which is provided below.

### DRAWINGS-FIGURES

FIG. 1 is an emergency process block diagram of the system.

FIG. 2 is a network view of the major elements of the system.

FIG. 3 and FIG. 3A represent a data diagram and data relationships of the system.

FIG. 4 is an entity relationship diagram

FIG. 5 is a subscriber information process block diagram of the system.

FIG. 6 is a provider information process block diagram.

FIG. 7 is a perspective view of the ID card showing how the permanent and replaceable appliqué fit together.

FIG. 8 is a perspective view of the back of the ID card showing the permanent and replaceable appliqué together.

FIG. 9 is a perspective detail drawing of the information contained on the front of the permanent ID card.

FIG. 10 is a perspective detail drawing of the information contained on the back of the permanent ID card.

FIG. 11 is a perspective detail drawing of the information contained on the appliqué that fits on the back of the card.

FIG. 12 is a block diagram showing how a subscriber can modify their information.

FIG. 13 is a block diagram showing how a provider can modify a subscriber's information.

FIG. 14 is a block diagram of the scheduling and appointment system.

### DRAWINGS-REFERENCE NUMERALS

| | | | |
|---|---|---|---|
| 25 | Subscriber or Customer | 27 | Telephone customer |
| | Online | | |
| 29 | Provider online | 31 | Applique printer |
| 33 | Communications network | 35 | Secure Socket Link |
| 37 | Application at website | 39 | Database and server |
| 41 | Phone order line | 42 | Intranet secure link |
| 45 | Emergency support clerk | 47 | Emergency provider |
| | | | online |
| 49 | Printed ID card | 51 | Text message |
| 53 | Text message network | 55 | Text messaging device |

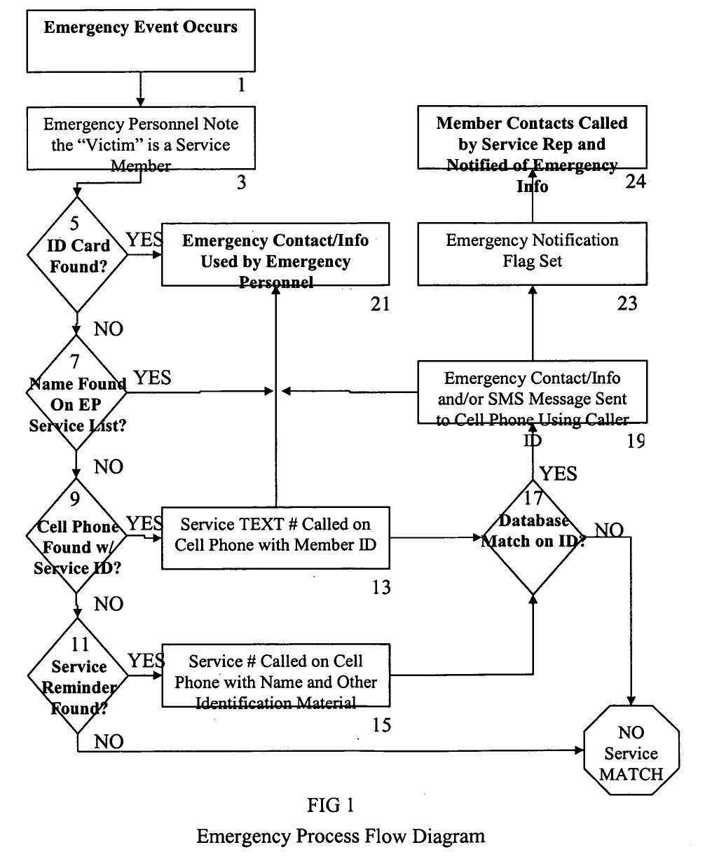

### Detailed Description-figs. 1-13—Preferred Embodiment

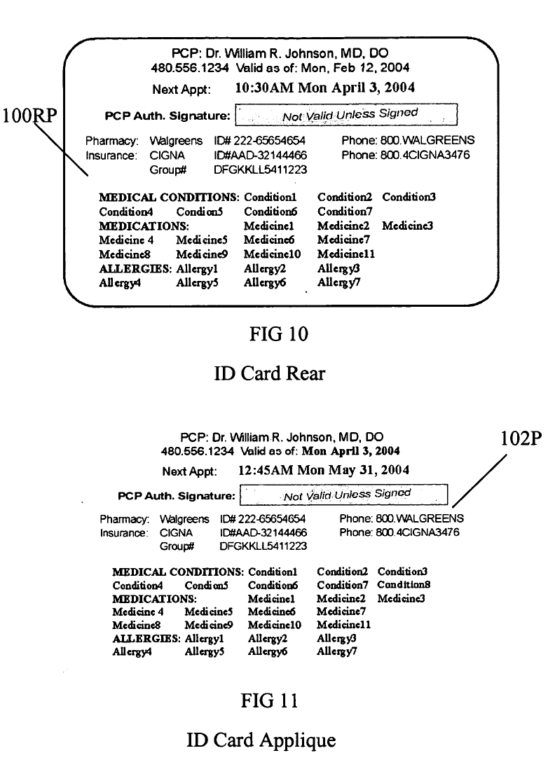

Referring more particularly to the drawings, a preferred embodiment of the present invention is shown in FIG. 1, depicting the emergency process diagram for the system. After the emergency has occurred 1 and EPs arrive, they note that the “person” is a service member 3 by seeing any of: windshield stickers, key ring tags, cell phone/pager stickers, and ID cards [FIG. 10, FIG. 11]. If an ID card is found 5, the EPs can choose to use the information contained on the card as appropriate 21. If the EPs choose, they can contact their own dispatch service to have the information relayed from the online database, read or sent to them. If the EPs find that the subscriber carries a cell phone 9 or other text messaging device they can look on the text messaging device for a Life+ID message or they can place a call to the text line, using the member ID as the reference ID and their own service specific password, and have a text message containing the emergency medical information sent to the calling phone. If the EPs find any other service sticker 11 they can place a phone call to the service line with the name of the “victim” and receive either a verbal or text emergency medical information message. After the service has been contacted about a member emergency on the text or service lines, a notification flag is set 23 in the database, and then the member's contacts are notified by the service 25.

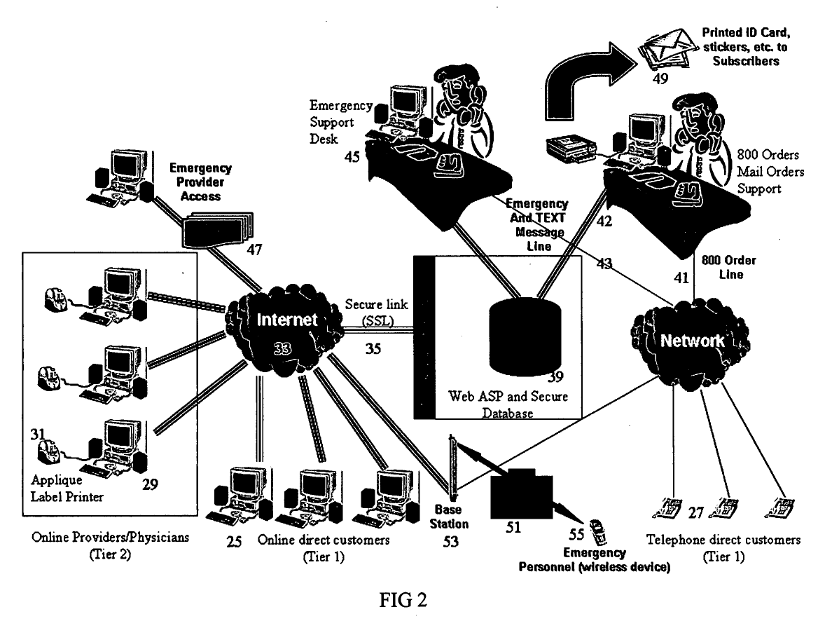

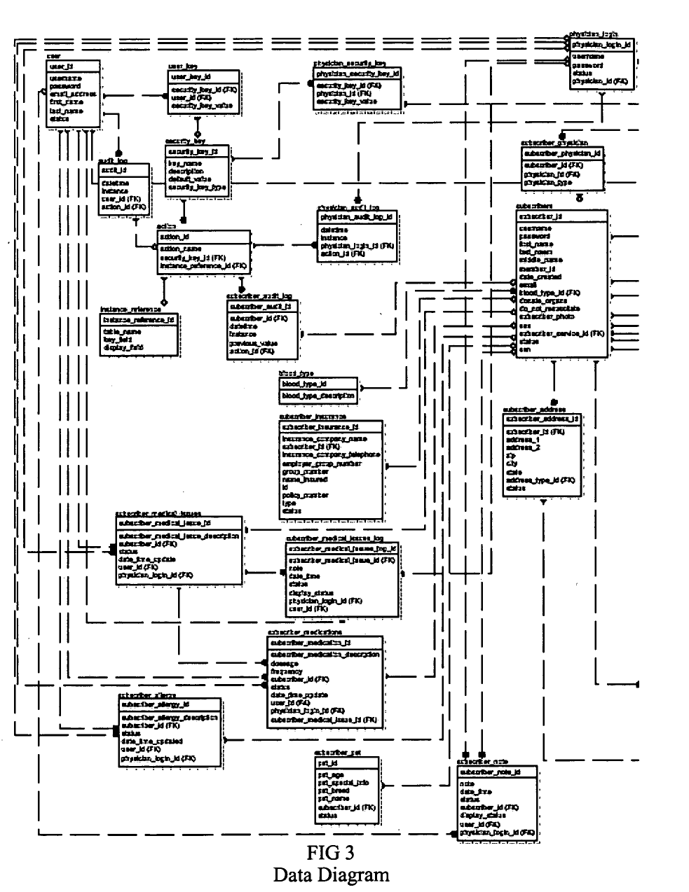

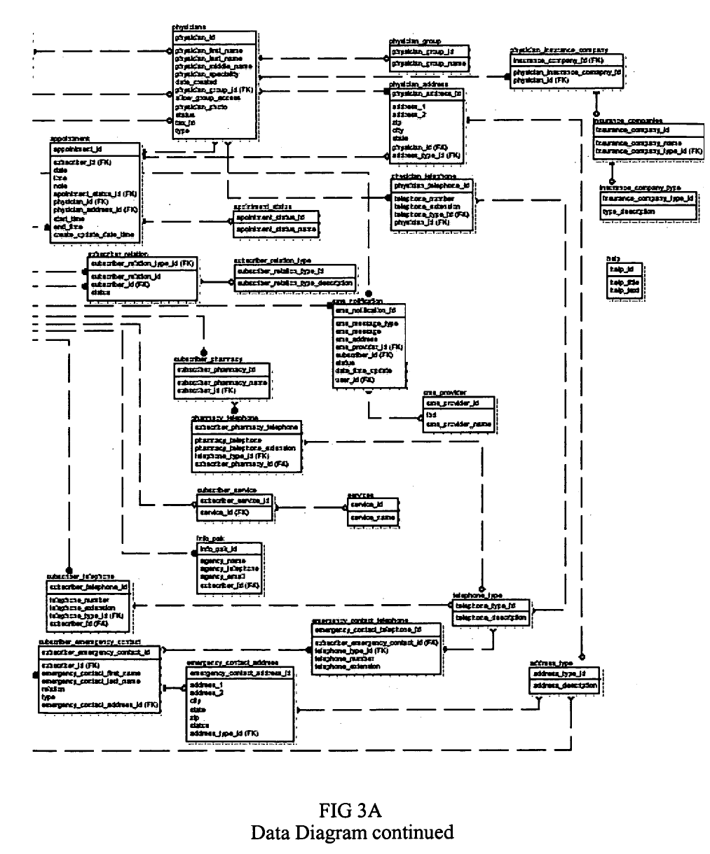

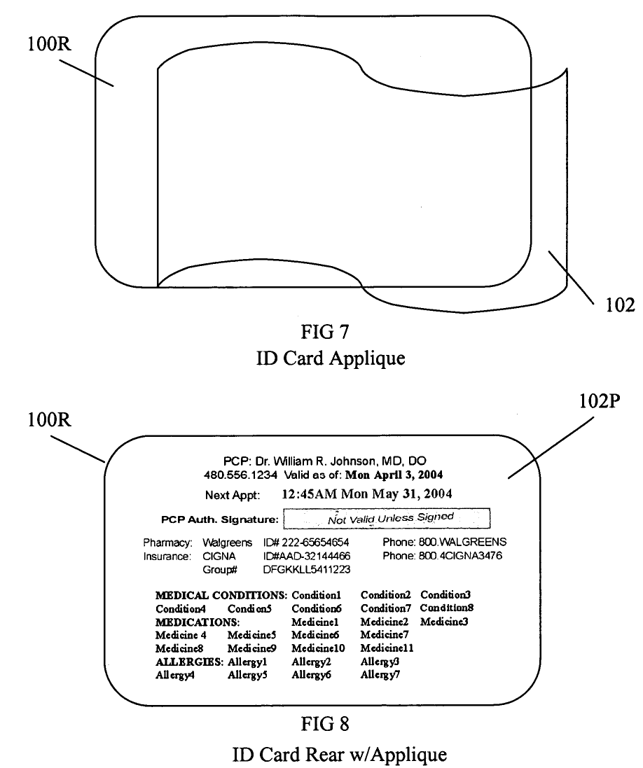

FIG. 2 depicts a network view of the system. The core of the system comprises the well known internet with centralized server, remote access devices (personal computers, PDAs, etc.) running a variety of operating systems with well known browsers, and a proprietary database and web application specific program 39. Direct online subscribers 25 attach to the service website 37 using a typical PC and browser across the internet 33 using secure links 35 to input or modify their accounts, thus ensuring that their information remains private. Alternatively, direct subscribers can place phone calls 27 into the service 41 and have a customer representative input or modify their accounts across the service's private network 42. Providers and/or physicians 29 can access the service across the internet 33 to input or modify their accounts or their linked subscriber's accounts. Whenever a new subscriber account is added, a new ID card and sticker package is mailed/delivered 49 to the subscriber. Physicians and providers use the locally attached label printers 31 provided by the service to print the ID card appliqués [FIG. 7, FIG. 11]. In all cases, a private centralized database 39 with data and data relationships depicted in FIG. 3 and FIG. 3A, is used for storage of all information, logs, attached records, and provider, and subscriber accounts. When a subscriber account is created or modified, their contact and medical information is enabled for emergency services of their choice 47 online, or via voice, email, or wireless text message 51. When emergency personnel activate a call 55 on an account, the call is routed to the emergency support desk 45 which then sends a wireless text message 51 through the base station 53 to the emergency personnel, or alternatively delivers a verbal update of the information to them.

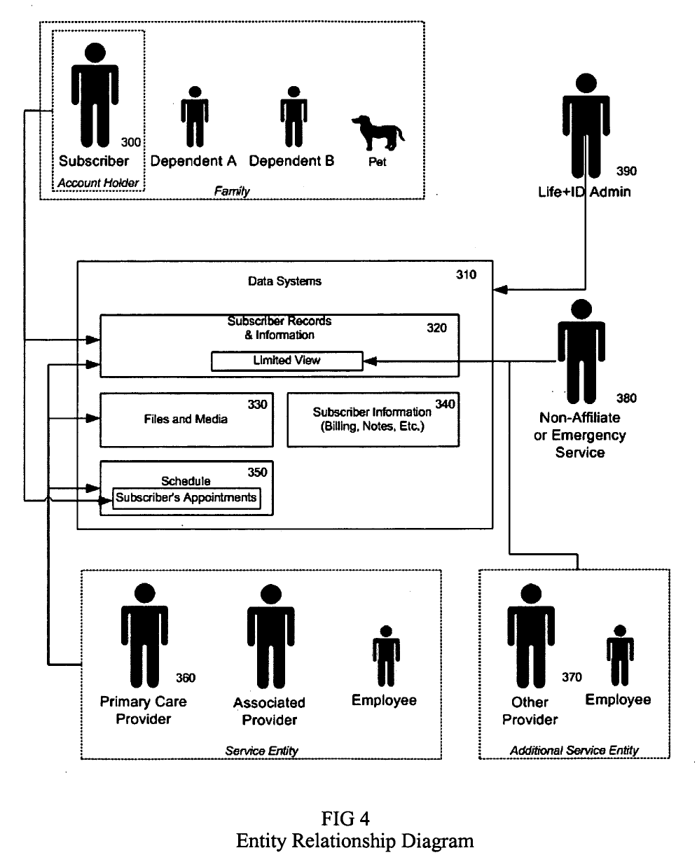

FIG. 4 depicts an entity relationship diagram. Subscribers 300 may have dependents and pets. Those subscribers are linked to the data system 310 which is an element of the central server host. Each subscriber has a unique electronic record 320 containing a variety of information as depicted in FIG. 3 and FIG. 3A. In addition, the subscriber record has a subscriber information 340 notes, logging and billing file. The primary care provider 360 may have associated providers and/or employees, and has a view of their associated subscribers that includes subscriber record 320, schedule and appointment information 350, files and media for attachments 330. Other providers 370 may also have employees, but have a limited view of the subscriber information 320. Non-affiliate providers and emergency personnel 380 have a limited view of a subscriber. They system administrators, Life+ID admin 390 has an unlimited view of all data systems records.

Operation—FIGS. 5,6,7,8,9,10,11,12,13,14

FIG. 5 depicts a subscriber account process flow diagram. A new subscriber accesses the service over the internet as shown in FIG. 2. They attach to a set of defined forms 60, enter the relevant information and submit the forms 62. A new unique member ID is created along with the associated information [64, FIG. 7, FIG. 8], stored in the website database 66, and moved to the offline secure database 68. Subsequently, the wireless text message contact database is updated 74 with the relevant messages and numbers, and the new subscriber information is attached to the emergency service list 76 and sent to the appropriate service(s). Additionally, a test wireless text message containing their initial information is sent to the subscriber 77, and the new subscriber's permanent ID card is custom printed, bundled with the other printed service materials 70 and sent to the subscriber 72.

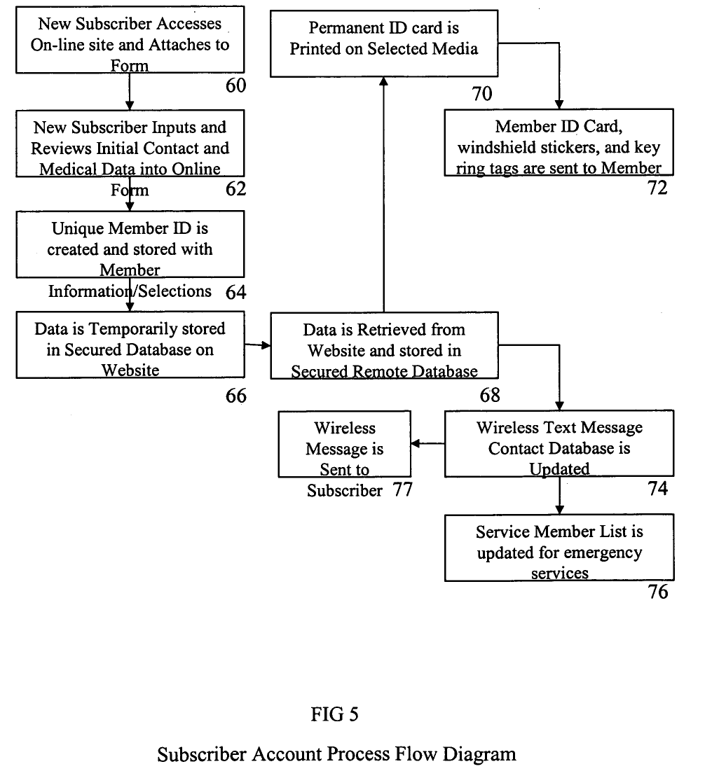

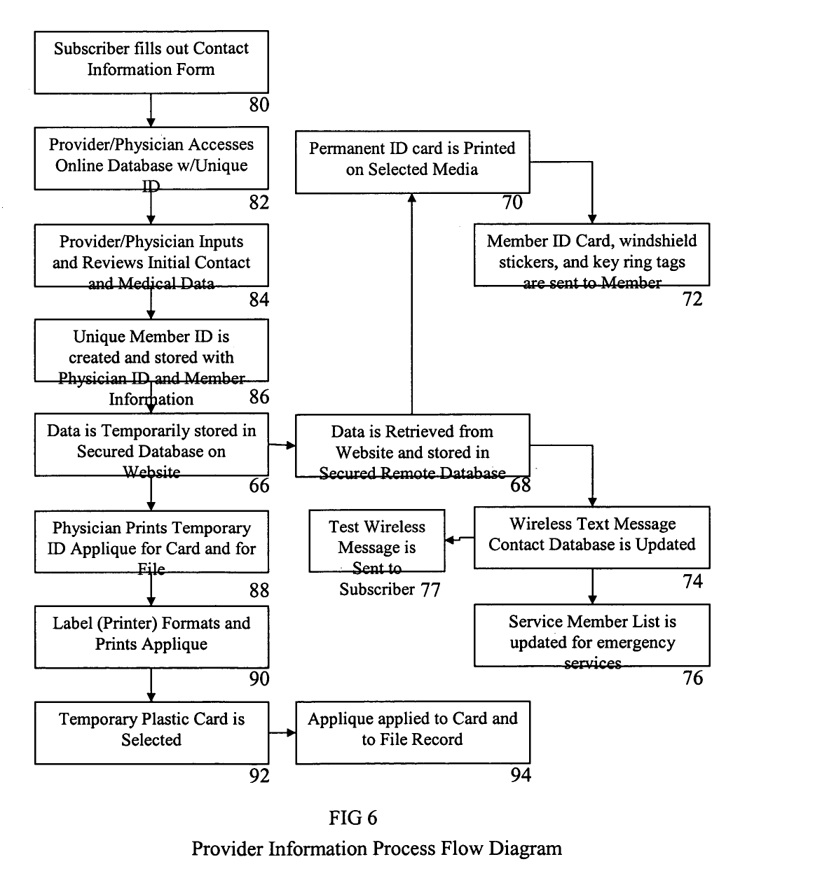

FIG. 6 depicts the process flow diagram when a provider creates a new subscriber account. The subscriber fills out a provided form with the relevant information 80, the provider accesses and attaches to his secured provider account via the internet 82, inputs the new subscriber account and generated a unique subscriber ID 86 associated with his provider account. Steps 66, 68, 70, 72, 74, 76, 77 are identical to those shown in FIG. 5. The provider also prints out a temporary ID appliqué for the card and for his patient file 88, selects a temporary ID card 90, and applies the appliqué to the card 94 which is then given to the subscriber.

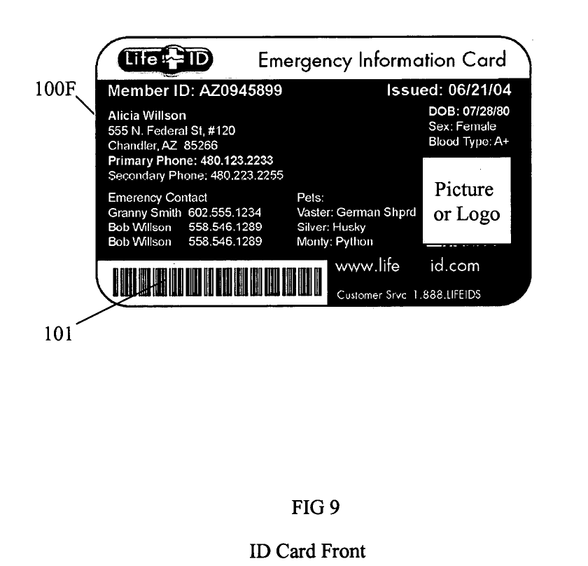

FIGS. 7, 8, 9, 10, and 11 depict the emergency contact and medical information ID card. The plastic card 100 has a rear side 100R with printed information types shown in FIG. 10 and a front side 100F with information types shown in FIG. 9. An overlay appliqué 102 that is typically slightly smaller in size than the card is printed using the thermographic printer 31 whenever a medical information or contact change is made, or whenever a new physician's appointment is made. This appliqué is then applied to the rear of the card over the old/existing information or previous appliqué.

FIG. 9 shows information embossed or printed directly on the front of the card media by the service. This information includes: a unique member ID; a card issue date; name, address, sex, and birth date of the card holder; up to three emergency contacts with name and phone numbers; a reserved space for future use, the service's website URL, the emergency service number, and the customer service phone number. The front of the card also contains a place for a photograph or logo and lastly a reserved area for subscriber information encoded in PDF417 format 101. This encoded information can contain unique biometric information and personal, medical, contact or other information from the subscriber's online record.

FIG. 11 shows information embossed or printed directly on the rear of the card media 100RP or the appliqué 102P by the service.

This information includes: the physician's name and unique ID; the physician's phone number; the valid date for this information; the subscriber's next appointment date/time with the physician; a physician's authorized signature block that validates the card information; and then certain subscriber medical information. The subscriber medical information includes: blood type, a list of medical conditions, a list of allergies, and a list of medications and immunizations.

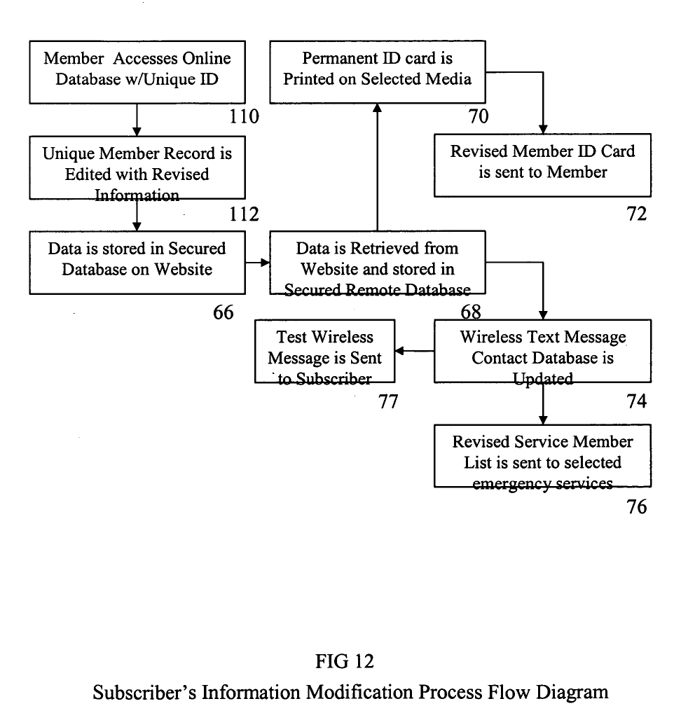

FIG. 12 shows the process used by a subscriber to modify their own account information. The subscriber accesses the online database with his unique ID 110, modifies his information as desired 112, and then proceeds to save the records into the database as before 66, 68, 70, 72, 74, 76.

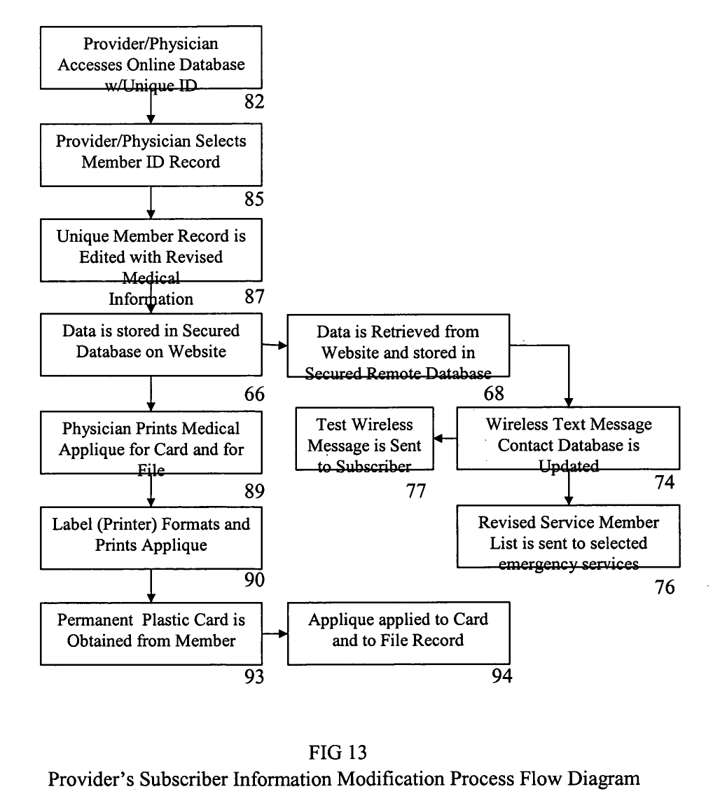

FIG. 13 shows the process used by a provider to modify the information of one of their associated subscribers. The provider accesses the website and their provider account with a unique ID 82; this gives them access to a list of their associated subscribers. They select the appropriate unique subscriber ID record 85; edit that record as desired 87; then proceed to store it as usual 66, 68, 74, 76. Additionally, since the modified subscriber record is normally associated with a visit to the provider by the subscriber, the provider prints out two revised appliqués, one for the ID card and one for their medical file 89. Subsequently, one of the appliqués is applied to the permanent ID card 93, 94.

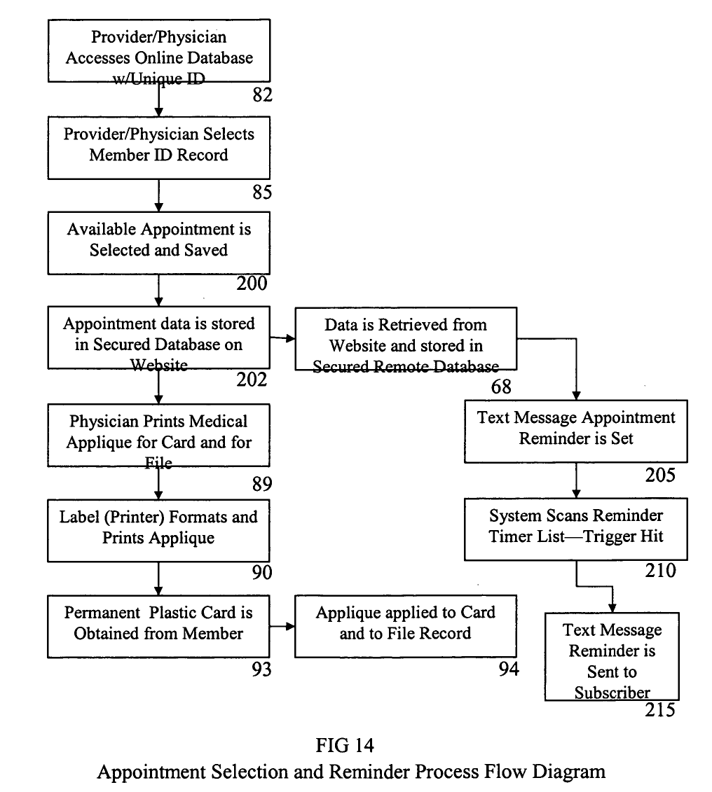

FIG. 14 shows the process used by a provider to schedule and save an appointment for an associated subscriber. The provider accesses the website and their provider account with a unique ID 82; this gives them access to a list of their associated subscribers. They select the appropriate unique subscriber ID record 85; select and create an appointment as desired 200; then proceed to store it in the appointment database 202.

Additionally, since the appointment and the modified subscriber record are normally associated with a visit to the provider by the subscriber, the provider prints out two revised appliqués, one for the ID card and one for their medical file 89. Subsequently, one of the appliqués is applied to the permanent ID card 93, 94. Thereafter, a text message appointment reminder 205 is set, and the system begins its normal scanning process. When the system hits the reminder 210, it processes the appointment reminder and generates and delivers the text message reminder 215.

Advantages

From the description above, a number of advantages of our invention become evident:

(a) the subscriber's information can be delivered by multiple means as circumstances warrant, including, by printed card, by transmission to a text messaging device, via the internet, or by electronic transmission, ensuring that emergency personnel and/or healthcare or other providers can receive the most up-to-date information on-demand;

(b) the ability of an associated provider to print, authorize, and attach an inexpensive card update appliqué ensures that the card reflects the most recent information when a subscriber leaves their appointment with that provider;

(c) the ability of multiple healthcare providers to separately enter issues and medications, yet see all medications and issues for a subscriber regardless of who entered them, helps to ensure more informed care for the subscriber;

(d) the ability of the system to attach other pertinent medical information to a subscriber's record helps to ensure better care for the subscriber;

(e) the ability of the system to log all changes to a subscriber's record ensures accountability and historical accuracy;

(f) the ability of the system to deliver an update of card information to a text messaging device ensures that the current emergency medical information can be received virtually anywhere that cell phones can be used;

(g) the ability of the system to deliver appointment reminders provides a service benefit to providers and subscribers, and an economic benefit to providers.

Conclusion, Ramifications, and Scope

Accordingly, the reader will see that the ability of this invention to provide global access to a subscriber's information in a very simple yet secure fashion, and to provide a durable, readable, and inexpensive portable media that contains key parts of that information and does not require special equipment to read yet can still be formally updated, provides a unique and substantial utility to the subscriber during both normal and emergency situations. Furthermore, the ability of a subscriber to allow and control access to their information and to enable inter-provider information exchange delivers a healthcare benefit to the subscriber and provides more up-to-date information for the healthcare provider to use in their decision making process.

Other capabilities inherent in the design provide additional advantages in that:

the text messaging ability of the system provides a method for sending and saving the most important information on-demand to the most widely publicly held messaging devices (cell phones, pagers, etc.), providing a much better and wider reaching communication and safety net;

the multiple information delivery methods (card, email, text messaging, email, voice, online access) provide choice to the user of the information and allow for the many real world scenarios encountered in emergency and non-emergency situations;

the logging utility provides an historical record of all actions taken by anyone accessing the system;

the access and security elements of the system provide for privacy of a subscriber's and provider's information;

the card appliqué update utility allows a provider to annotate their own records and provide a permanent reminder to the subscribe—both of which make the information process more efficient;

the PDF417 encoding area allows for biometric and other textual information to be stored in the card and allows civil service personnel to read that information;

the reminder utility provides an automatic text message about forthcoming appointments to be delivered to the subscriber and benefits the provider by eliminating a heretofore costly manual process.

Modifications and alternative embodiments of the invention will be apparent to those skilled in the art given the previous description. For example, the database can be enhanced to include condition specific information; the ID card can be modified to contain other information; the ID card can be delivered in other formats; the system can be used for other service provider applications like dentists, salons, psychiatrists, the PDF417 encoding mechanism can be changed, etc. This description is to be construed as illustrative only, and is for the purpose of teaching those skilled in the art the best mode of carrying out the invention. The details of the system, process, and method may be varied substantially without departing from the spirit of the invention, and the exclusive use of all modifications that come within the scope of the appended claims is reserved.

We claim:

1. A system for storing and providing personal and medical information, comprising:
a) a global communications data network;
b) a central server storage device attached to said communications network, said server including a first communications interface for data and a second communications interface for messaging;
c) a personal computing device (PCD) linked to said global communications network; said PCD including a first connection port;
d) an appliqué printing device communicably connected to the PCD first connection port;
e) a host application system in communication with said server, said application implementing a method for receiving, storing, and providing personal and medical information, said application implementing a method for providing electronic commerce.

2. a method for receiving, storing, and providing personal and medical information comprising:
a) receiving personal and medical information about a person;
b) generating a unique person identifier and storing said identifier and said information;
c) receiving information about a service provider;
d) generating a unique provider identifier and storing said identifier and said information;
e) linking said person to said service provider;
f) receiving information from said service provider about said person;
g) storing said information;
h) securing said information with logon and encrypting protection;
i) providing restrictions on information changes that apply to each of said subscriber and said person;
j) changing information of said person or said provider;
k) transmitting notification to said person when a change has been made to their information;
l) retrieving information about said person, said provider, and combined information about said person and provider;
m) placing said combined information onto a portable media;
n) receiving requests for combined information from a third party;
o) transmitting said combined information to said third party;
p) transmitting notice to person that said combined information was transmitted to said third party;
q) logging each of previously noted actions.

3. a portable data and ID card comprising:
a) a printed first surface and a printed second opposing surface, said surfaces containing combined information about a person and provider from the host storage device;
b) an encoded summary printed on the first surface containing the combined information about said person and provider from the host storage device;
c) a printed appliqué covering and applied to said second surface, containing combined information about said person and provider from the system.

4. a method for providing scheduling and appointment information, said method comprising:
a) receiving an appointment request for a person and a provider;
b) selecting a date, time, and location for said appointment request;
c) saving said appointment request in a manner associating it with said person and subscriber;
d) retrieving said appointment request;
e) generating a reminder about said appointment;
f) transmitting said reminder to said person.

5. the method of claim 2 wherein said personal and medical information includes unique identifier, validation date, name, date of birth, blood type, biometric identifier, multiple pet names and types, multiple emergency contact names and phone numbers, multiple providers, medical conditions, medications, immunizations, allergies, primary care physician name, primary physician phone number.

6. the method of claim 2 wherein said receiving of information is via mail, fax, phone, or direct computer input using host application system.

7. the method of claim 2 wherein said changing of information is via direct computer input using said host application system.

8. the method of claim 2 wherein said receiving of requests from a third party is via phone, email, fax, or computer.

9. the method of claim 2 wherein said transmitting of requests to a third party is via voice, text message, email, or fax.

10. the method of claim 2 wherein said retrieving is performed by searching a database on said server using unique identifier, name, associated provider list, appointment date, or biometric match.

11. a method for providing electronic commerce, said method comprising:
a) receiving transaction information about said person;
b) allotting costs associated with selected services to said person;
c) generating a cost transaction record;
d) performing an approval check of said cost transaction record;
e) saving said cost transaction record after said approval.

12. the method of claim 3 wherein said encoding is via PDF417.

13. the method of claim 4 wherein said receiving, said selecting, said saving, and said retrieving of said appointments is via direct computer input using said host application system.

14. the method of claim 4 wherein said transmitting is via text message, voice, email, or fax.
